(19) United States
(12) Patent Application Publication
(10) Pub. No.: US 2010/0321876 A1
(43) Pub. Date: Dec. 23, 2010

(54) BRACKET AND COMPUTER SYSTEM HAVING THE SAME

(75) Inventors: Lei Liu, Shenzhen City (CN); Xiao-Zhu Chen, Shenzhen City (CN)

Correspondence Address: Altis Law Group, Inc.;ATTN: Steven Reiss, 288 SOUTH MAYO AVENUE, CITY OF INDUSTRY, CA, 91789, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/545,043

(22) Filed: Aug. 20, 2009

(30) Foreign Application Priority Data
Jun. 18, 2009 (CN) 200910303413.6

(51) Int. Cl. G06F 1/16; A47B 96/06

(52) U.S. Cl. 361/679.22; 248/295.11

(57) ABSTRACT

A computer system having a monitor includes a bracket fixed to a back cover of the monitor. The bracket includes a main body fixed to the back cover, a first fixation board, and a second fixation board. The first fixation board and the second fixation board are movably mounted to the main body. An enclosure is received in a space bounded by the main body, the first fixation board, and the second fixation board.

### BACKGROUND

1. Technical Field

The present disclosure relates to computer systems, and particularly to computer system having a bracket.

2. Description of Related Art

With computers becoming smaller and smaller, a kind of mini information technology extended (ITX) motherboard with a size of 170 mm*170 mm has been developed. A mini enclosure adapted to such a mini ITX motherboard can be fixed to a back cover of a monitor via screws. However, affixing the enclosure to the monitor in this way may result in an imbalanced monitor that is easy to tip over.

### BRIEF DESCRIPTION OF THE DRAWINGS

FIG. 1 is an exploded, isometric view of an exemplary embodiment of a computer system, the computer system including a bracket, a monitor, and an enclosure.

FIG. 2 is an exploded, isometric view of an exemplary embodiment of the bracket of FIG. 1.

FIG. 3 is an assembled, isometric view of the bracket of FIG. 2.

FIG. 4 is an assembled, isometric view of the bracket and the monitor of FIG 1.

FIG. 5 is an isometric view of the computer system of FIG. 1.

### DETAILED DESCRIPTION

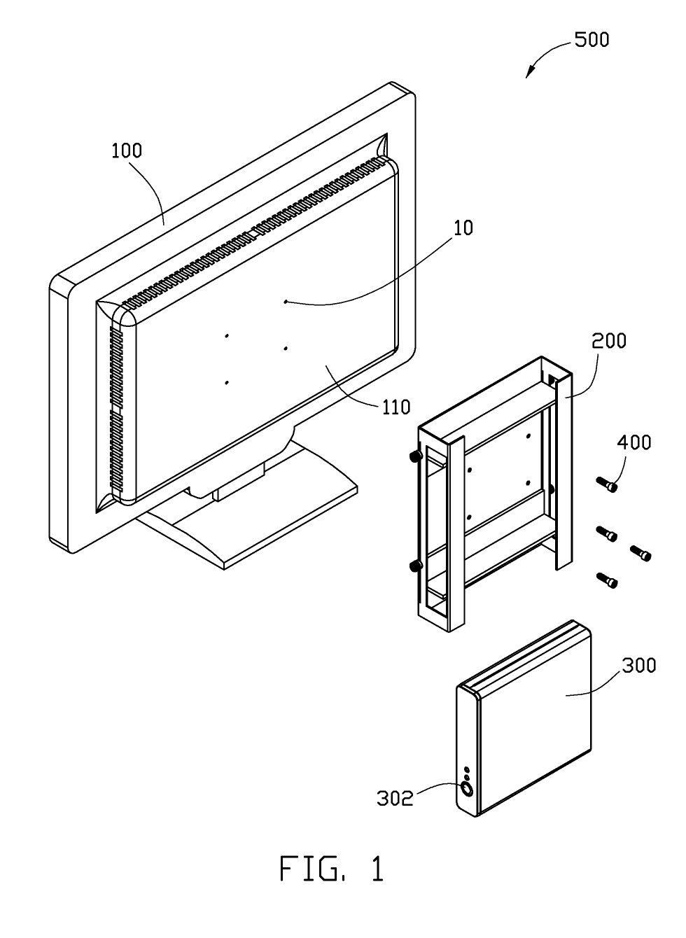

Referring to FIG. 1, an exemplary embodiment of a computer system 500 includes a monitor 100, a bracket 200, an enclosure 300, and four screws 400.

The monitor 100 includes a back cover 110. The back cover 110 defines four screw holes 10 therein, for fixing the bracket 200. The enclosure 300 is a mini enclosure.

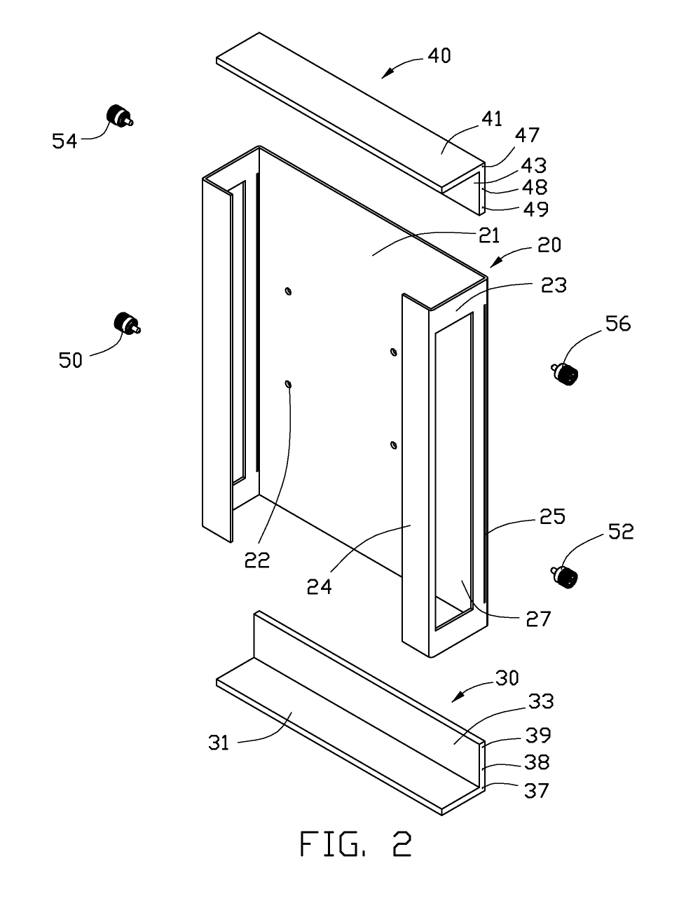

Referring to FIG. 2, the bracket 200 includes a main body 20, a first fixation board 30, a second fixation board 40, and four screws 50, 52, 54, and 56.

The main body 20 includes a rectangular baseboard 21. The baseboard 21 defines four through holes 22, corresponding to the screw holes 10 of the back cover 110. Two side boards 23 vertically extend from two opposite sides of the baseboard 21. A flange 24 vertically extends from a side opposite to the baseboard 21 of each side board 23 towards the other side board 23. Each of the side boards 23 defines an opening 27, and a gap 25 adjacent to the baseboard 21 and parallel to a joining line between the side board 23 and the baseboard 21.

The first fixation board 30 includes a blocking plate 31 and a mounting plate 33 vertically extending from a side of the blocking plate 31. Each of opposite end surfaces of the mounting plate 33 defines three screw holes 37, 38, and 39.

The second fixation board 40 includes a blocking plate 41 and a mounting plate 43 vertically extending from a side of the blocking plate 41. Each of opposite end surfaces of the mounting plate 43 defines three screw holes 47, 48, and 49.

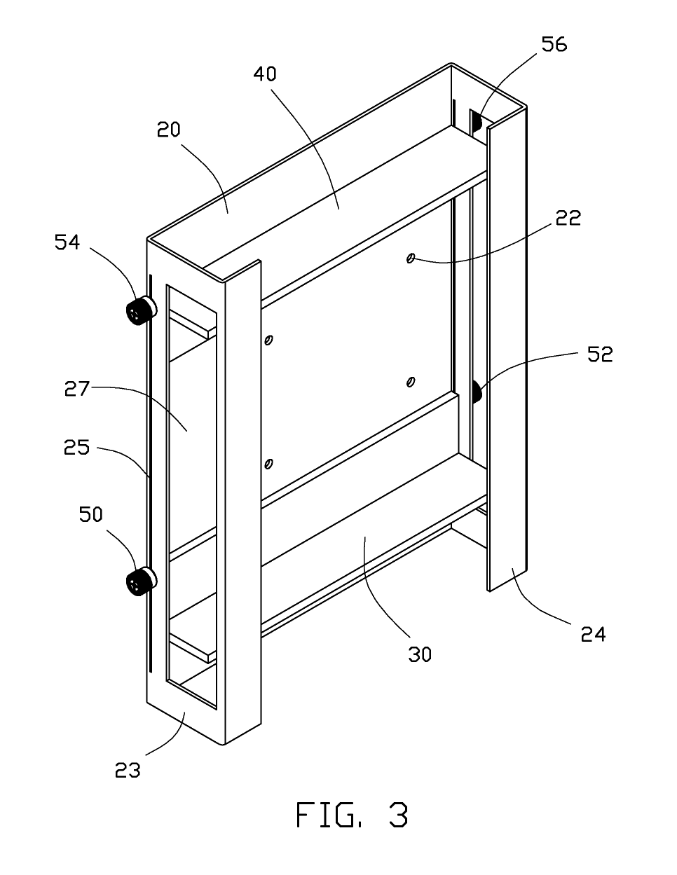

Referring to FIG. 3, in assembling the bracket 200, the mounting plate 33 of the first fixation board 30 is attached to the baseboard 21 of the main board 20 and between the side boards 23. The screw 50 passes through the gap 25 of one side board 23 to be screwed in the screw hole 39 in a corresponding end surface of the first fixation board 30. The screw 52 passes through the gap 25 of the other side board 23 to be screwed in the screw hole 39 in the other end surface of the first fixation board 30. Thereby, the first fixation board 30 is fixed to the main body 20.

The mounting plate 43 of the second fixation board 40 is attached to the baseboard 21 of the main board 20 and between the side boards 23. The screw 54 passes through the gap 25 in one side board 23 to be screwed in the screw hole 47 of a corresponding end surface of the second fixation board 40. The screw 56 passes through the gap 25 in the other side board 23 to be screwed in the screw hole 47 of the other end surface of the second fixation board 40. Thereby, the second fixation board 40 is fixed to the main body 20.

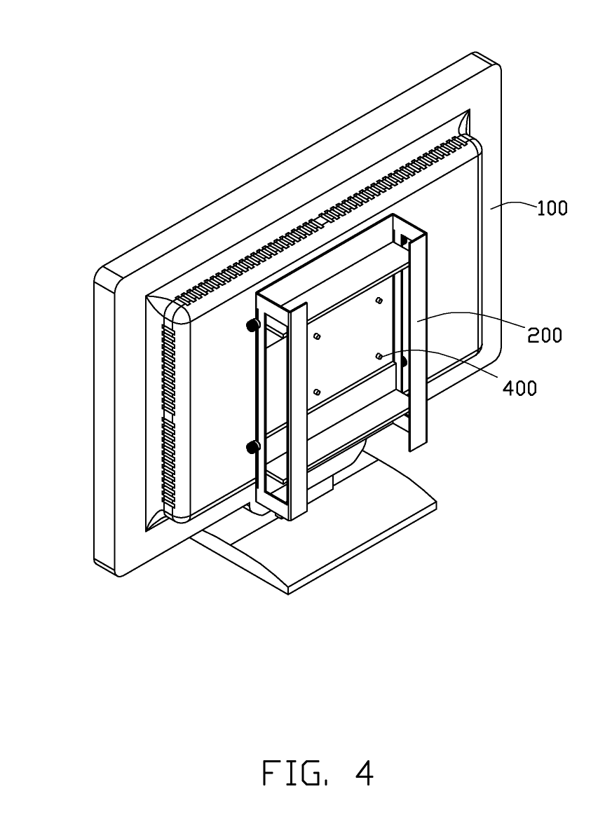

Referring to FIG. 4, in assembling the bracket 200 to the monitor 100, the screws 400 respectively pass through the corresponding through holes 22 of the bracket 20 and are screwed in the corresponding screw holes 10 of the monitor 100, thereby to fix the bracket 200 to the back cover 110 of the monitor 100.

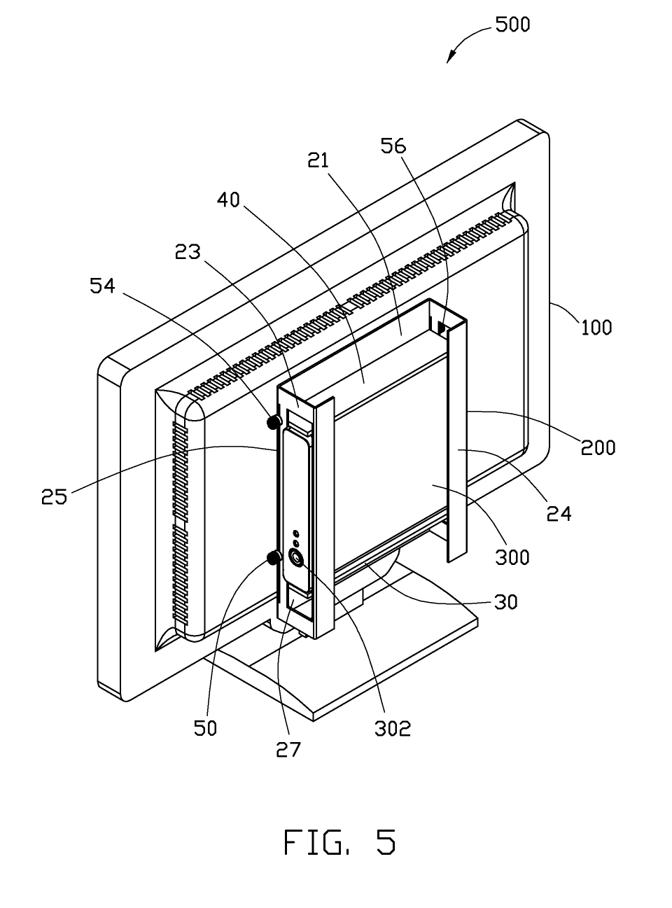

Referring to FIG. 5, in assembling the enclosure 300 to the bracket 200, the screws 54 and 56 are released, and the second fixation board 40 is removed from the main body 20. The enclosure 300 is placed on the blocking plate 31 of the first fixation board 30. The flanges 24 of the main body 20 and the baseboard 21 sandwich the enclosure 300 therebetween. Sidewalls of the enclosure 300 having interfaces 302 such as input/output interfaces face the openings 27 of the main body 20, thereby the interfaces 302 of the enclosure 300 are exposed through the openings 27, and peripheral equipment such as a mouse and a keyboard can be conveniently connected to the interfaces 302.

The second fixation board 40 is attached to the main body 20. The mounting plate 43 is fixed to the main body 20 via the screws 54 and 56. Thereby, the blocking plate 41 of the second fixation board 40 and the blocking plate 31 of the first fixation board 30 sandwich the enclosure 30 therebetween. The screws 50, 52, 54, and 56 may be loosened to position the first fixation board 30 and the second fixation board 40 relative to the main body 20, thereby to adjust a position of the enclosure 300 relative to the bracket 200, to make the monitor 100 stable. Thus, a balanced and stable computer system 500 is achieved that cannot be easily tipped over.

It is to be understood, however, that even though numerous characteristics and advantages of the present disclosure have been set forth in the foregoing description, together with details of the structure and function of the disclosure, the disclosure is illustrative only, and changes may be made in details, especially in matters of shape, size, and arrangement of parts within the principles of the disclosure to the full extent indicated by the broad general meaning of the terms in which the appended claims are expressed.

What is claimed is:

1. A computer system, comprising:
a monitor;
an enclosure; and
a bracket fixed to a back cover of the monitor; wherein the bracket comprises a main body, a first fixation board, and a second fixation board; wherein the main body comprises a baseboard and two side boards substantially vertically extending from opposite sides of the baseboard; wherein each of the side boards comprises a flange extending from the side board towards the other side board; wherein the first fixation board and the second fixation board are movably fixed to the corresponding side boards, and the enclosure is received in a space bounded by the baseboard, the two side boards, the first fixation board, and the second fixation board.

2. The computer system of claim 1, wherein each of the side boards defines a gap, and two opposite ends of each of the first fixation board and the second fixation board define a screw hole respectively; wherein a screw passes through the gap in each side board and is screwed in the corresponding screw hole of each of the first fixation board and the second fixation board, thereby to fix the first fixation board and the second fixation board to the two side boards of the bracket.

3. The computer system of claim 2, wherein each of the first fixation board and the second fixation board both comprises a blocking plate and a mounting plate vertically extending from a side of the blocking plate; wherein the screw holes are defined opposite end surfaces of the mounting plate.

4. The computer system of claim 1, wherein each side board defines an opening to expose interfaces of the enclosure therethrough.

5. The computer system of claim 1, wherein the back cover of the monitor defines at least one screw hole, and the baseboard of the bracket defines at least one through hole corresponding to the screw hole of the back cover; wherein at least one screw passes through the at least one through hole of the bracket and is screwed into the at least one screw hole of the back cover of the monitor, thereby to fix the bracket to monitor.

6. A monitor, comprising:
a back cover;
an enclosure; and
a bracket comprising:
a first fixation board;
a second fixation board; and
a main body fixed to the back cover; wherein the first fixation board and the second fixation board are movably fixed to the main body;
wherein the enclosure is received in a space bounded by the main body, the first fixation board, and the second fixation board.

7. The monitor of claim 6, wherein the main body comprises a baseboard fixed to and contacting the back cover, and two side boards substantially perpendicularly extending from opposite sides of the baseboard and away from the back cover, wherein each of the side boards defines a gap adjacent to the baseboard, and each of opposite ends of each of the first fixation board and the second fixation board define a screw hole; wherein a screw passes through the gap of each side board and is screwed into the screw hole of a corresponding end of each of the first fixation board and the second fixation board, thereby to fix the first fixation board and the second fixation board to the main body.

8. The monitor of claim 7, wherein each of the first fixation board and the second fixation board comprises a blocking plate perpendicular to the baseboard of the main body, and a mounting plate extending from a side of the blocking plate and contacting the baseboard of the main body; wherein the screw holes are defined in opposite end surfaces of the mounting plate.

9. The monitor of claim 7, wherein the back cover defines at least one screw hole, and the baseboard of the bracket defines at least one through hole corresponding to the screw hole of the back cover; wherein at least one screw passes through the at least one through hole of the bracket and is screwed into the at least one screw hole of the back cover, thereby to fix the bracket to the back cover.

10. The monitor of claim 6, wherein each of the side boards defines an opening to expose interfaces of the enclosure therethrough.

11. A bracket, comprising:
a first fixation board;
a second fixation board; and
a main body comprising a baseboard, and two side boards vertically extending from opposite sides of the baseboard; wherein a flange vertically extends from a side opposite to the baseboard of each side board towards the other side board; wherein the first fixation board and the second fixation board are movably fixed between the side boards, a space is bounded by the baseboard, the first and second fixation boards, to receive an enclosure.

12. The bracket of claim 11, wherein each of the side boards defines a gap, and each of opposite ends of each of the first fixation board and the second fixation board define a screw hole; wherein a plurality of screws pass through the gaps and are screwed into the screw holes of the first fixation board and the second fixation board, thereby fixing the first fixation board and the second fixation board between the two side boards.

13. The bracket of claim 12, wherein each of the first fixation board and the second fixation board both comprises a blocking plate and a mounting plate vertically connected to the blocking plate; wherein the screw holes are defined in opposite end surfaces of the mounting plate.

14. The bracket of claim 11, wherein each of the side boards defines an opening to expose interfaces of the enclosure therethrough.
